(19) United States
(12) Patent Application Publication
(10) Pub. No.: US 2007/0279810 A1
(43) Pub. Date: Dec. 6, 2007

(54) Current-perpendicular-to-plane magnetic head and magnetic disk apparatus using the same

(75) Inventors: Tomomi Funayama, Tokorozawa-shi (JP); Katsuhiko Koui, Ome-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,360

(22) Filed: May 31, 2007

(30) Foreign Application Priority Data
May 31, 2006 (JP) 2006-152121

(51) Int. Cl. G11B 5/127

(52) U.S. Cl. 360/324.1

(57) ABSTRACT

According to one embodiment, a current-perpendicular-to-plane magnetic head includes a magnetoresistive film including a pinned layer, an intermediate layer and a free layer, a pair of magnetic shields serving as electrodes provided over and under the magnetoresistive film, and a pair of biasing films provided on both sides of the magnetoresistive film through an insulating film, in which an angle θ between a magnetization direction of the pinned layer and a magnetization direction of the free layer is set to 5°≦θ<90°, or a bias point is set to 5%≦BP<50%, at zero external field.

### CROSS-REFERENCE TO RELATED APPLICATIONS

This application is based upon and claims the benefit of priority from Japanese Patent Application No. 2006-152121, filed May 31, 2006, the entire contents of which are incorporated herein by reference.

### BACKGROUND

1. Field

One embodiment of the present invention relates to a current-perpendicular-to-plane magnetic head and a magnetic disk apparatus using the current-perpendicular-to-plane magnetic head.

2. Description of the Related Art

As magnetoresistive films (spin valve films) expected to produce improved magnetoresistive effects, those of a current-perpendicular-to-plane type have been studied (see, for example, U.S. Pat. No. 5,668,688).

Conventional current-perpendicular-to-plane magnetoresistive films are designed so that the magnetization direction of the pinned layer is fixed in one direction, while the magnetization direction of the free layer is made orthogonal to that of the pinned layer at zero external field (medium field) by applying a bias field to the free layer.

However, it has been found that if the magnetization direction of the free layer is orthogonal to that of the pinned layer, noise in the read output is disadvantageously made remarkable as the current density of a sense current is increased. This problem is referred to as spin transfer-induced noise (STIN). However, no effective method for inhibiting STIN has been known.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a cross-sectional view parallel to the air bearing surface of a current-perpendicular-to-plane magnetic head according to an embodiment of the present invention;

FIG. 2 is a cross-sectional view of the magnetoresistive film in FIG. 1;

FIG. 3 is a diagram schematically showing magnetization directions of the biasing films, the free layer and the second pinned layer in a current-perpendicular-to-plane magnetic head according to an embodiment of the present invention as viewed from the substrate surface;

FIG. 4 is a diagram schematically showing the magnetization directions of the biasing films, the free layer and the second pinned layer in a current-perpendicular-to-plane magnetic head according to another embodiment of the present invention as viewed from the substrate surface;

FIG. 5 is a diagram showing the angle θ between Mf and Mp2 at zero external field and the relationship between an output (V) and an external field (Hex) for a current-perpendicular-to-plane magnetic head according to an embodiment of the present invention;

FIG. 6 is a perspective view schematically illustrating the magnetization directions of a first pinned layer, a second pinned layer and a free layer in a current-perpendicular-to-plane magnetic head according to another embodiment of the present invention;

FIG. 7 is a diagram showing the directions and magnitudes of Hp1, Hp2, Hin and Htot;

FIG. 8 is a diagram showing the angle θ between Mf and Mp2 at zero external field and the relationship between an output (V) and an external field (Hex) for a current-perpendicular-to-plane magnetic head according to another embodiment of the present invention;

FIG. 9 is a diagram showing the angle θ between Mf and Mp2 at zero external field and the relationship between an output (V) and an external field (Hex) for a current-perpendicular-to-plane magnetic head in Comparative Example 3;

FIG. 10 is a diagram showing the waveform of a read output from a current-perpendicular-to-plane magnetic head in Example 5;

FIG. 11 is a diagram showing the waveform of a read output from the current-perpendicular-to-plane magnetic head in Comparative Example 3; and

FIG. 12 is a perspective view of a magnetic disk apparatus according to another embodiment of the present invention.

### DETAILED DESCRIPTION

Various embodiments according to the invention will be described hereinafter with reference to the accompanying drawings. In general, according to one embodiment of the present invention, there is provided a current-perpendicular-to-plane magnetic head comprising: a magnetoresistive film including a pinned layer, an intermediate layer, and a free layer; a pair of magnetic shields serving as electrodes provided over and under the magnetoresistive film; and a pair of biasing films provided on both sides of the magnetoresistive film through an insulating film, wherein an angle θ between a magnetization direction of the pinned layer and a magnetization direction of the free layer is set to 5°≦θ<90°, or a bias point is set to 5%≦BP<50%, at zero external field.

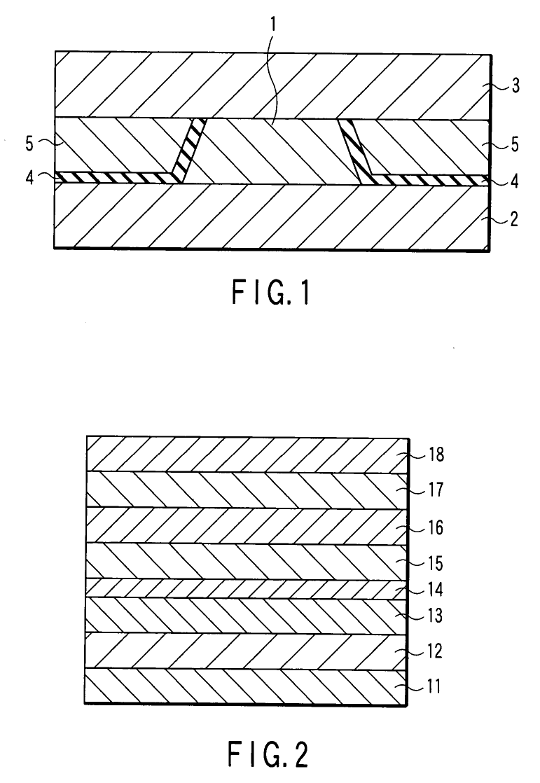

FIG. 1 is a cross-sectional view parallel to the air bearing surface of a current-perpendicular-to-plane magnetic head according to an embodiment of the present invention. A magnetic shield 2 serving as a lower electrode made of NiFe is formed on an AlTiC (Al₂O₃—TiC) substrate (not shown). A magnetoresistive film 1 is formed on the magnetic shield 2 serving as the lower electrode. A magnetic shield 3 serving as an upper electrode made of NiFe is formed on the magnetoresistive film 1. Biasing films 5 made of Cr/CoCrPt are formed on the both sides of the magnetoresistive film 1 through an insulating film 4 made of alumina. A sense current is supplied to the magnetoresistive film 1 in the perpendicular direction to the film plane using the magnetic shield 2 serving as the lower electrode and the magnetic shield 3 serving as the upper electrode. A bias field is applied to the magnetoresistive film 1 by the biasing films 5.

FIG. 2 is a cross-sectional view of the magnetoresistive film 1 in FIG. 1. The magnetoresistive film 1 comprises an underlayer 11 made of Ta and Ru, an antiferromagnetic layer 12 made of IrMn, a first pinned layer 13 made of CoFe, a metal layer 14 made of Ru, a second pinned layer 15 made of CoFe, an intermediate layer 16 made of Cu, a free layer 17 made of CoFe and NiFe, and a protective layer 18 made of Ru and Ta, which layers are stacked in this order.

Here, the underlayer 11 may be Ta/NiFeCr, Ta/Cu, or the like. The antiferromagnetic layer 12 may be PtMn or the like. A pinned layer in FIG. 2 is a so-called synthetic pinned layer including the first pinned layer 13, the metal layer 14 and the second pinned layer 15. However, the pinned layer may be a single ferromagnetic layer. Each of the first pinned layer 13, the second pinned layer 15 and the free layer 17 may be made of an alloy containing any of Fe, Co, and Ni instead of the afore-mentioned materials. The intermediate layer 16 may be made of Au or Ag, or a composite comprising an insulator such as alumina and current paths formed in the insulator and made of Cu, Au, Ag, or the like.

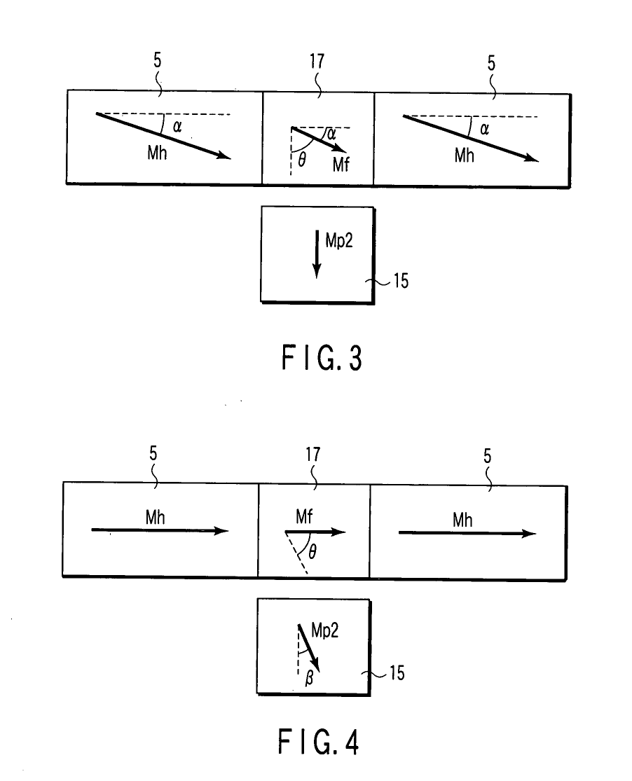

FIG. 3 is a diagram schematically showing the magnetization directions of the biasing films, free layer and second pinned layer in a current-perpendicular-to-plane magnetic head according to an embodiment of the present invention as viewed from the substrate surface. In FIG. 3, the magnetizing directions of the magnetizations Mh of the biasing films 5 are inclined by a from the width direction (track width direction) of the magnetoresistive element. This inclines the direction of the bias field applied to the free layer 17 from the biasing films 5 by α to the width direction of the magnetoresistive element. The magnetization Mf of the free layer 17 is also inclined by α to the width direction of the magnetoresistive element. On the other hand, the magnetization Mp2 of the second pinned layer 15 is fixed in the height direction of the magnetoresistive element. As a result, the angle θ between the magnetization Mf of the free layer 17 and the magnetization Mp2 of the second pinned layer 15 is expressed by: θ=90°−α.

FIG. 4 is a diagram schematically showing the magnetization directions of the biasing films, free layer and second pinned layer in a current-perpendicular-to-plane magnetic head according to another embodiment of the present invention as viewed from the substrate surface. In FIG. 4, the magnetization Mp2 of the second pinned layer 15 is fixed in a direction inclined by β to the height direction of the magnetoresistive film. On the other hand, the magnetizing directions of the magnetizations Mh of the biasing films 5 coincide with the width direction (track width direction) of the magnetoresistive film. As a result, the angle θ between the magnetization Mf of the free layer 17 and the magnetization Mp2 of the second pinned layer 15 is expressed by: θ=90°−β.

In both FIGS. 3 and 4, α or β is set so as to satisfy the following condition: 5°≦θ<90°. Further, although not shown, the magnetizations Mh of the biasing films 5 may be fixed in a direction inclined by α to the width direction (track width direction) of the magnetoresistive film as well as the magnetization Mp2 of the second pinned layer 15 may be fixed in a direction inclined by β to the height direction of the magnetoresistive film. In this case, the angle between the magnetization Mf of the free layer 17 and the magnetization Mp2 of the second pinned layer 15 is expressed by: θ=90°−α−β. Also in this case, α and β are set so as to satisfy the condition: 5°≦θ<90°.

FIG. 5 is a diagram showing the angle θ between Mf and Mp2 at zero external field (medium field) and the relationship between an output (V) and the external field (Hex) for a current-perpendicular-to-plane magnetic head according to an embodiment of the present invention. Using ΔVo and ΔVs shown in FIG. 5, a bias point BP is defined as follows:
BP=(ΔVo/ΔVs)*100(%).

The current-perpendicular-to-plane magnetic head in Example 1, 2 or 3, α and/or β are set so that θ has the specific value shown in Table 1. Table 1 also shows the BP value corresponding to θ. In fact, the BP value depends on the θ value. For θ=0°, BP=0 (%); for θ=90°, BP=50 (%); and for θ=180°, BP=100 (%). As shown in Table 1, when θ is in a range of: 5°≦θ<90°, any BP satisfies the condition: 5%≦BP<50%. For comparison, current-perpendicular-to-plane magnetic heads set to θ>90° and BP>50% are produced (Comparative Examples 1 and 2).

Table 1 shows signal-to-noise ratio (SNR) and bit error rate (BER) measured for the current-perpendicular-to-plane magnetic heads in Examples 1, 2 and 3 and Comparative Examples 1 and 2. Table 1 shows that for the current-perpendicular-to-plane magnetic heads in Examples 1, 2 and 3 according to the present invention within the range of 45°≦θ≦85°, a high SNR and a good BER is obtained. In the case where θ≦5° or BP<5%, since ΔVo becomes too small, SNR and BER cannot be substantially measured. Further, in the case where θ=90°, SNR may be high or low and a high SNR cannot be obtained stably.

These results indicate that with the current-perpendicular-to-plane magnetic head according to the embodiment of the present invention, setting the angle between the magnetization Mf of the free layer and the magnetization Mp2 of the second pinned layer so as to satisfy the condition: 5°≦θ<90°, provides a high SNR, resulting in a good BER.

TABLE 1

| | | | | Comparative | Comparative |
|---|---|---|---|---|---|
| | Example 1 | Example 2 | Example 3 | Example 1 | Example 2 |
| θ | 45 | 70 | 85 | 95 | 110 |
| (deg.) | | | | | |
| BP | 15 | 33 | 45 | 55 | 67 |
| (%) | | | | | |
| SNR | 16 | 18 | 18 | 10 | 9 |
| (dB) | | | | | |
| log | −5.8 | −6 | −6.2 | −4.2 | −4 |
| (BER) | | | | | |

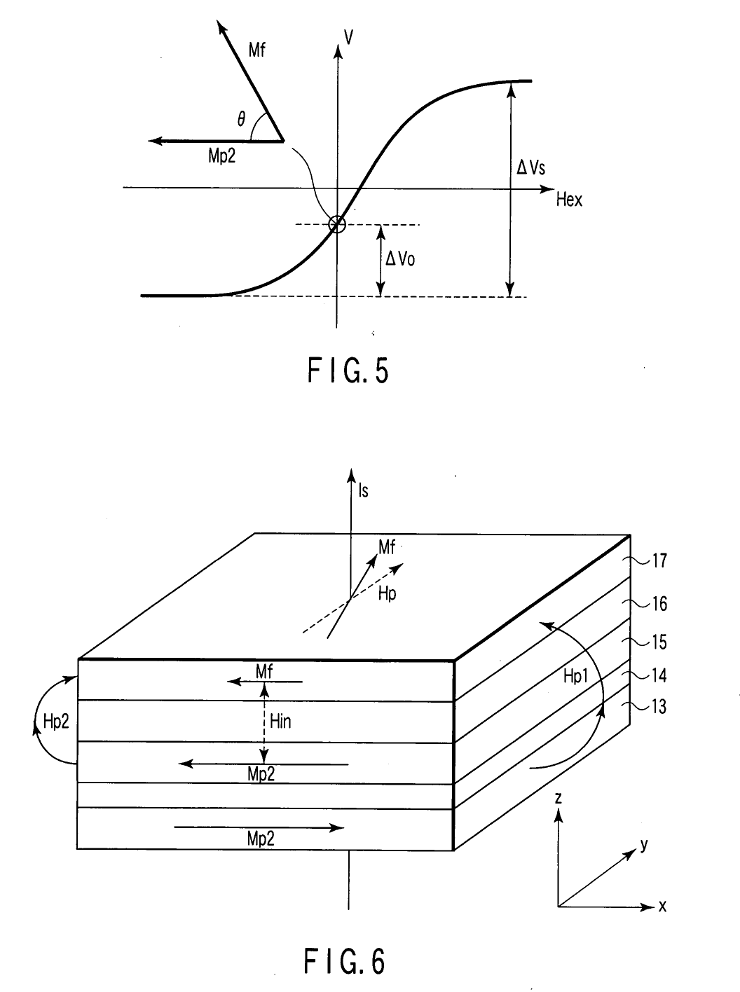

FIG. 6 is a perspective view schematically illustrating the magnetization directions of the first pinned layer 13, second pinned layer 15 and free layer 17 in a current-perpendicular-to-plane magnetic head according to another embodiment of the present invention. In this figure, the air bearing surface is located at the left end. This figure shows the magnetization directions at zero external field (medium field). The magnetization Mp1 of the first pinned layer 13 is substantially fixed in the depicted direction (rightward) by exchange coupling with the antiferromagnetic layer. The magnetization Mp2 of the second pinned layer is antiferromagnetically coupled to Mp1 via the metal layer 14 and substantially fixed in a direction antiparallel to Mp1 (leftward). The magnetization of the free layer 17 is affected by a bias field Hb from the biasing films 5, a magnetostatic coupling field Hp1 from the magnetization Mp1 of the first pinned layer 13, a magnetostatic coupling field Hp2 from the magnetization Mp2 of the second pinned layer 15, and an interlayer coupling field Hin with the magnetization Mp2 of the second pinned layer 15. It should be noted that Hb acts almost in the direction of the y axis and Hp1, Hp2 and Hin act almost in the direction of the x axis.

The product Mp1*tp1 of the saturation magnetization and thickness of the first pinned layer and the product Mp2*tp2 of the saturation magnetization and thickness of the second pinned layer are set so as to satisfy the condition: MP1*tp1>Mp2*tp2, as shown in Table 2 (Examples 4 and 5). To meet this condition, the first and second pinned layers are made of the same Co₉₀Fe₁₀ alloy so that Mp1=Mp2 and have thicknesses tp1 and tp2 so as to satisfy the condition: tp1>tp2. Alternatively, for example, the first and second pinned layers may have the same thickness and different compositions such that the condition: Mp1>Mp2, is satisfied. Any compositions and thicknesses may be used provided that the condition: Mp1*tp1>Mp2*tp2 is met.

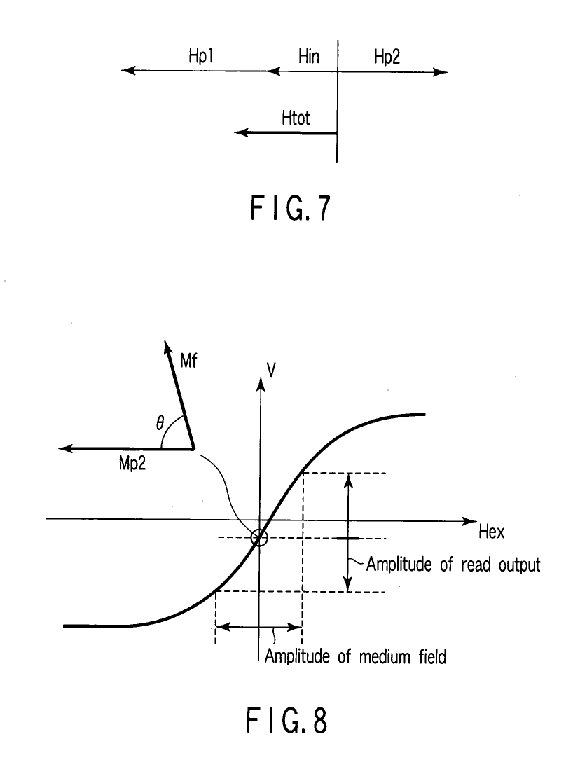

With the above conditions met, Hp1, Hp2 and Hin have the directions and magnitudes shown in FIG. 7. Accordingly, a magnetic field acting on the free layer 17 in the direction of the x axis is Htot shown in FIG. 7. A synthetic field of Hb and Htot acts on the magnetization Mf of the free layer 17. Mf is oriented parallel to the synthetic magnetic field. In general, Hin needs to be at most about 10 Oe, so that the direction of Htot generally coincides with that of one of Hp1 and Hp2 which has the higher magnitude.

FIG. 8 shows the angle θ between Mf and Mp2 at zero external field and the relationship between the output (V) and the external field (Hex) for the above current-perpendicular-to-plane magnetic head. Table 2 shows θ and BP of current-perpendicular-to-plane magnetic heads set so as to satisfy the condition: Mp1*tp1>Mp2*tp2 (Examples 4 and 5). As shown in Table 2, in the current-perpendicular-to-plane magnetic heads in Examples 4 and 5, the angle θ between Mf and Mp2 is set to 5°≦θ<90°, and also BP is set to 5%≦BP<50%. Table 2 shows the measurements of the signal-to-noise ratio (SNR) and bit error rate (BER) for the current-perpendicular-to-plane magnetic heads in Examples 4 and 5.

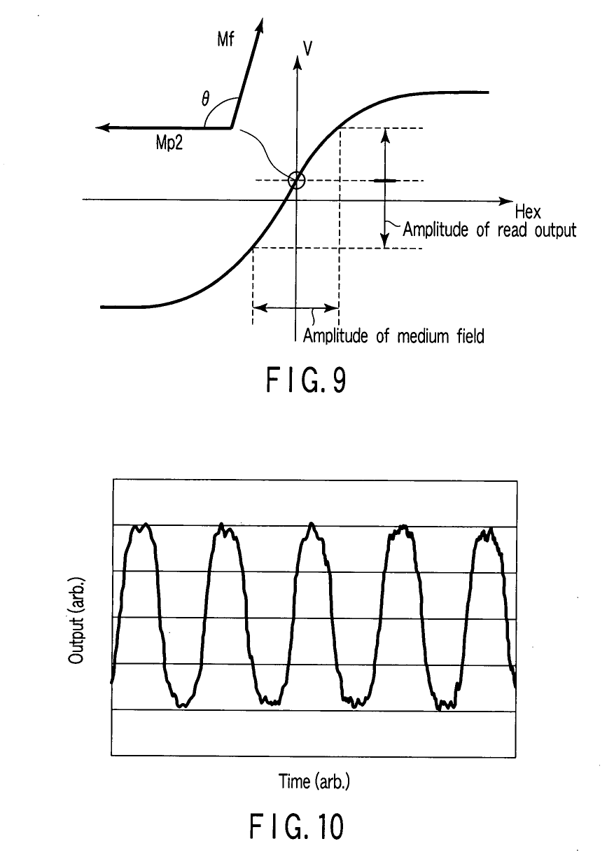

For comparison, a current-perpendicular-to-plane magnetic head set so as to satisfy the condition: Mp1*tp1<Mp2*tp2 is produced (Comparative Example 3). FIG. 9 shows the angle θ between Mf and Mp2 at zero external field and the relationship between the output (V) and the external field (Hex) for the current-perpendicular-to-plane magnetic head in Comparative Example 3. Table 2 shows θ and BP of Comparative Example 3. As shown in Table 2, for the current-perpendicular-to-plane magnetic head in Comparative Example 3, the angle θ between Mf and Mp2 is set to 90°<θ, and also BP is set to 50%<BP. Table 2 also shows the measurements of the signal-to-noise ratio (SNR) and bit error rate (BER) for the current-perpendicular-to-plane magnetic head in Comparative Example 3.

As is apparent from the results in Table 2, the current-perpendicular-to-plane magnetic heads in Examples 4 and 5 provide a high SNR, resulting in a good BER.

FIG. 10 shows the waveform of a read output from the current-perpendicular-to-plane magnetic head in Example 5. In association with the read output waveform in FIG. 10, FIG. 8 shows the amplitude of the medium field and the amplitude of the read output. These figures show that the current-perpendicular-to-plane magnetic head in Example 5 makes low noise and provides a good read waveform, although the waveform symmetry deviates very slightly toward a plus side.

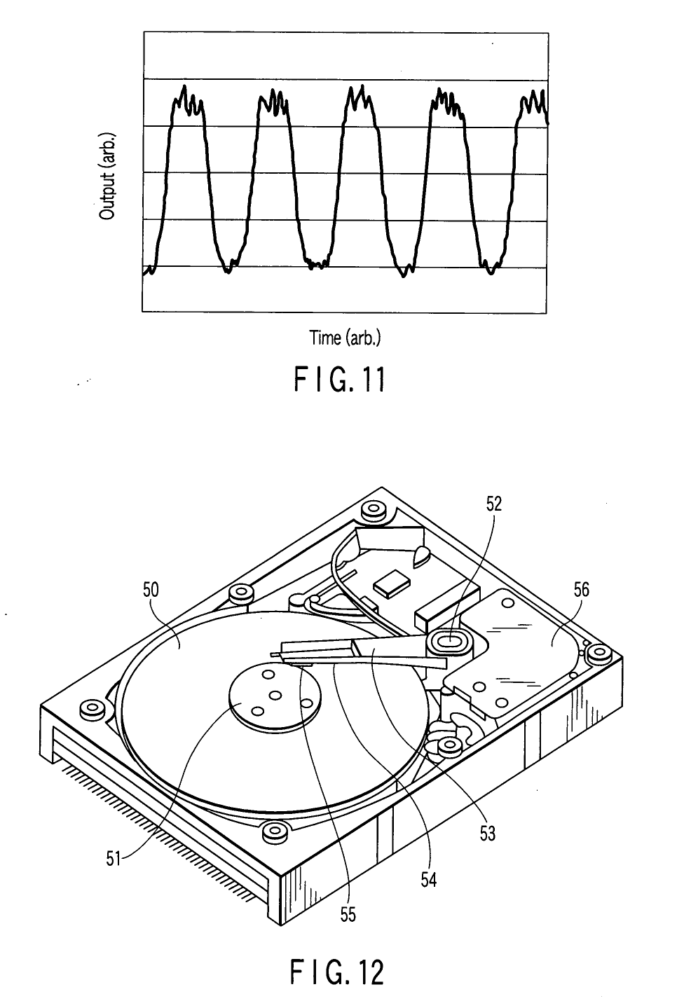

Similarly, FIG. 11 shows the waveform of a read output from the current-perpendicular-to-plane magnetic head in Comparative Example 3. In association with the read output waveform in FIG. 11, FIG. 9 shows the amplitude of the medium field and the amplitude of the read output. These figures show that the current-perpendicular-to-plane magnetic head in Comparative Example 3 exhibits a peculiar noise on one side of the waveform (plus side) with the waveform symmetry deviating toward a minus side. The peculiar noise observed on one side of the waveform in Comparative Example 3 is caused by spin transfer-induced noise (STIN) in the current-perpendicular-to-plane magnetic head. This is observed significantly in the case where 90°≦θ. Occurrence of STIN causes the noise to be observed on one side of the reproduction waveform, disrupting the waveform symmetry to degrade SNR and thus BER.

In contrast, the current-perpendicular-to-plane magnetic head according to the embodiment of the present invention can inhibit possible spin transfer-induced noise, providing a high SNR and thus a good BER.

As shown in FIG. 6, with the current-perpendicular-to-plane magnetic head according to the present invention, the STIN inhibiting effect is enhanced by supplying a sense current from the pinned layer to the free layer. Accordingly, the sense current is preferably supplied in this direction.

TABLE 2

| | | | Comparative |
|---|---|---|---|
| | Example 4 | Example 5 | Example 3 |
| Mp1 * tp1 | 4.5 | 4.2 | 3.8 |
| (T · nm) | | | |
| Mp2 * tp2 | 4 | 4 | 4 |
| (T · nm) | | | |
| θ (deg.) | 70 | 85 | 100 |
| BP (%) | 33 | 45 | 59 |
| SNR (dB) | 19 | 18 | 10 |
| log (BER) | −6 | −6.2 | −4.2 |

FIG. 12 is a perspective view of a magnetic disk apparatus according to an embodiment of the present invention. A magnetic disk 50 is rotatably mounted on a spindle motor 51. A head suspension assembly, including an actuator arm 53, a suspension 54 and a head slider 55, is attached to a pivot 52 provided in the vicinity of the magnetic disk 50. The suspension 54 is held at one end of the actuator arm 53 to support the slider 55 so that the slider 55 is supported to face the recording surface of the magnetic disk 50. The current-perpendicular-to-plane magnetic disk shown in any of the embodiments is incorporated in the head slider 55. A voice coil motor 56 serving as an actuator is provided at the other end of the actuator arm 53. The voice coil motor 56 actuated the head suspension assembly to position the magnetic head at any radial position over the magnetic disk 50. The magnetic disk apparatus has the current-perpendicular-to-plane magnetic head shown in any of the above embodiments and thus provides a high SNR and thus a good BER.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A current-perpendicular-to-plane magnetic head comprising:
a magnetoresistive film including a pinned layer, an intermediate layer, and a free layer;
a pair of magnetic shields serving as electrodes provided over and under the magnetoresistive film; and
a pair of biasing films provided on both sides of the magnetoresistive film through an insulating film,
wherein an angle θ between a magnetization direction of the pinned layer and a magnetization direction of the free layer is set to 5°≦θ<90°, or a bias point is set to 5%≦BP<50%, at zero external field.

2. The magnetic head according to claim 1, wherein magnetizations of the biasing films are magnetized in a direction inclined to a width direction of the magnetoresistive film.

3. The magnetic head according to claim 1, wherein the magnetization of the pinned layer is magnetized in a direction inclined to a height direction of the magnetoresistive film.

4. The magnetic head according to claim 1, wherein the magnetoresistive film includes an antiferromagnetic layer, a synthetic pinned layer including a first pinned layer, a metal layer and a second pinned layer, an intermediate layer, and a free layer, and wherein, supposing that products of a saturation magnetization and a thickness for the first and second pinned layers constituting the synthetic pinned layer are Mp1*tp1 and Mp2*tp2, respectively, a relationship Mp1*tp1>Mp2*tp2 is satisfied.

5. A magnetic disk apparatus comprising:
a magnetic disk; and
the current-perpendicular-to-plane magnetic head according to claim 1.
